(19) United States
(12) Patent Application Publication
(10) Pub. No.: US 2025/0139515 A1
(43) Pub. Date: May 1, 2025

(54) INTERACTIVE CONFIGURATION OF DEPLOYED DETECTION MODELS

(71) Applicant: KONINKLIJKE PHILIPS N.V., EINDHOVEN (NL)

(72) Inventor: IKARO GARCIA ARAUJO DA SILVA, Noord-Brabant (NL)

(21) Appl. No.: 18/834,262

(22) PCT Filed: Jan. 17, 2023
(86) PCT No.: PCT/EP2023/051007

§ 371 Date: Jul. 30, 2024

Related U.S. Application Data
(60) Provisional application No. 63/305,814, filed on Feb. 2, 2022.

(51) Int. Cl. G06N 20/00

(52) U.S. Cl. CPC G06N 20/00

(57) ABSTRACT

A system includes a memory and a processor. The memory stores instructions, a threshold parameter corresponding to classifier detection thresholds for a trained detection model, and performance information associated with the threshold parameter. The processor executes the instructions to detect classifier detection thresholds set for the trained detection model, and identify for the classifier detection thresholds, false alarm gains, precision values and recall values. The processor outputs a signal that includes the false alarm gains, the precision values, and the recall values.

### BACKGROUND

Detection systems developed based on data include, but are not limited to, artificial intelligence models trained based on data. Machine learning is a category of artificial intelligence trained based on data. Machine learning (ML) solutions are becoming more popular and frequent in, for example, medical and critical-care applications. These solutions often involve the detection of an infrequent abnormal condition (positive class) among a large number of instances of normal conditions (negative class), though this type of problem is not limited to the context of medical and critical-care applications or to machine learning. Examples of other contexts that deal with an infrequent abnormal condition among a large number of instances of normal conditions range from email filters to threat detection systems used in military applications. The large class imbalance may be due to low population prevalence and causes significant deployment issues even for the best-performing artificial intelligence models, resulting in decreased utility value to the user. The large class imbalance between positive and negative can be further increased in the deployment of machine learning models, where the positive class prevalence can be much larger than that of the training set used to develop the machine learning models. Two key issues are false alarms overload and alarm desensitization, and these issues are further aggravated by the user's inability or knowledge as to how or whether to change the default classifier detection thresholds used by detection models. In other words, how can the user easily configure a classifier threshold so that the costs and risks associated with false positives and missed hits better reflect the user's values?

### SUMMARY

According to an aspect of the present disclosure, a system includes a memory and a processor. The memory stores instructions, a threshold parameter corresponding to classifier detection thresholds for a trained detection model, and performance information associated with the threshold parameter. The processor executes the instructions. When executed by the processor, the instructions cause the processor to detect a first classifier detection threshold set for the trained detection model; identify, for the first classifier detection threshold, a first false alarm gain, a first precision value and a first recall value; detect a second classifier detection threshold set for the trained detection model; identify, for the second classifier detection threshold, a second false alarm gain, a second precision value and a second recall value; and output a signal that includes the first false alarm gain, the first precision value, the first recall value, the second false alarm gain, the second precision value and the second recall value.

According to another aspect of the present disclosure, a method includes storing, in a memory, instructions, a threshold parameter corresponding to classifier detection thresholds for a trained detection model, and performance information associated with the threshold parameter; detecting, by a processor, a first classifier detection threshold set for the trained detection model; identifying, by the processor for the first classifier detection threshold, a first false alarm gain, a first precision value and a first recall value; detecting, by the processor, a second classifier detection threshold set for the trained detection model; identifying, by the processor for the second classifier detection threshold, a second false alarm gain, a second precision value and a second recall value; and outputting a signal that includes the first false alarm gain, the first precision value, the first recall value, the second false alarm gain, the second precision value and the second recall value.

According to another aspect of the present disclosure, a tangible non-transitory computer readable storage medium stores a computer program, a threshold parameter corresponding to classifier detection thresholds for a trained detection model, and performance information associated with the threshold parameter. The computer program, when executed by a processor, causes a computer apparatus to: detect a first classifier detection threshold set for the trained detection model; identify, for the first classifier detection threshold, a first false alarm gain, a first precision value and a first recall value; detect a second classifier detection threshold set for the trained detection model; identify, for the second classifier detection threshold, a second false alarm gain, a second precision value and a second recall value; and output a signal that includes the first false alarm gain, the first precision value, the first recall value, the second false alarm gain, the second precision value and the second recall value.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1A illustrates a system for interactive configuration of deployed detection models, in accordance with a representative embodiment.

FIG. 1B illustrates a device for interactive configuration of deployed detection models, in accordance with a representative embodiment.

FIG. 1C illustrates a controller for interactive configuration of deployed detection models, in accordance with a representative embodiment.

FIG. 2 illustrates a method for interactive configuration of deployed detection models, in accordance with a representative embodiment.

FIG. 3 illustrates an interactive graphical user interface for interactive configuration of deployed detection models, in accordance with a representative embodiment.

FIG. 4 illustrates an example application of interactive graphical user interface for interactive configuration of deployed detection models, in accordance with a representative embodiment.

FIG. 5 illustrates another interactive graphical user interface for interactive configuration of deployed detection models, in accordance with a representative embodiment.

FIG. 6 illustrates a computer system, on which a method for interactive configuration of deployed detection models is implemented, in accordance with another representative embodiment.

### DETAILED DESCRIPTION

In the following detailed description, for the purposes of explanation and not limitation, representative embodiments disclosing specific details are set forth in order to provide a thorough understanding of an embodiment according to the present teachings. Descriptions of known systems, devices, materials, methods of operation and methods of manufacture may be omitted so as to avoid obscuring the description of the representative embodiments. Nonetheless, systems, devices, materials and methods that are within the purview of one of ordinary skill in the art are within the scope of the present teachings and may be used in accordance with the representative embodiments. It is to be understood that the terminology used herein is for purposes of describing particular embodiments only and is not intended to be limiting. The defined terms are in addition to the technical and scientific meanings of the defined terms as commonly understood and accepted in the technical field of the present teachings.

It will be understood that, although the terms first, second, third etc. may be used herein to describe various elements or components, these elements or components should not be limited by these terms. These terms are only used to distinguish one element or component from another element or component. Thus, a first element or component discussed below could be termed a second element or component without departing from the teachings of the inventive concept.

The terminology used herein is for purposes of describing particular embodiments only and is not intended to be limiting. As used in the specification and appended claims, the singular forms of terms ‘a’, ‘an’ and ‘the’ are intended to include both singular and plural forms, unless the context clearly dictates otherwise. Additionally, the terms “comprises”, and/or “comprising,” and/or similar terms when used in this specification, specify the presence of stated features, elements, and/or components, but do not preclude the presence or addition of one or more other features, elements, components, and/or groups thereof. As used herein, the term “and/or” includes any and all combinations of one or more of the associated listed items.

Unless otherwise noted, when an element or component is said to be “connected to”, “coupled to”, or “adjacent to” another element or component, it will be understood that the element or component can be directly connected or coupled to the other element or component, or intervening elements or components may be present. That is, these and similar terms encompass cases where one or more intermediate elements or components may be employed to connect two elements or components. However, when an element or component is said to be “directly connected” to another element or component, this encompasses only cases where the two elements or components are connected to each other without any intermediate or intervening elements or components.

The present disclosure, through one or more of its various aspects, embodiments and/or specific features or sub-components, is thus intended to bring out one or more of the advantages as specifically noted below. For purposes of explanation and not limitation, example embodiments disclosing specific details are set forth in order to provide a thorough understanding of an embodiment according to the present teachings. However, other embodiments consistent with the present disclosure that depart from specific details disclosed herein remain within the scope of the appended claims. Moreover, descriptions of well-known apparatuses and methods may be omitted so as to not obscure the description of the example embodiments. Such methods and apparatuses are within the scope of the present disclosure.

As described herein, an interactive tool is configured to assist users in modifying the operating classifier detection thresholds for deployed detection models. The tool enables informed classifier detection threshold selection choices by contextualizing the expected false alarm rates, precision, and recall of the detection models as a function of classifier detection threshold values. This allows the users to understand the impact of classifier detection threshold changes on the numbers of false alarms, in addition to making it easier to change model classifier detection threshold settings. The interactive tool enables users to provide interactive input of changes to see the effects of changing classifier detection threshold selections by clicking or dragging points on graphs. When the user wants to set a new default, the new classifier detection threshold gets uploaded and the previous (e.g., default) classifier detection threshold for the machine learning model is overwritten. The interactive tool may be applied to any classification or detection task that would allow the user to change or select classifier detection threshold values in a way that is relevant to their own needs and circumstances.

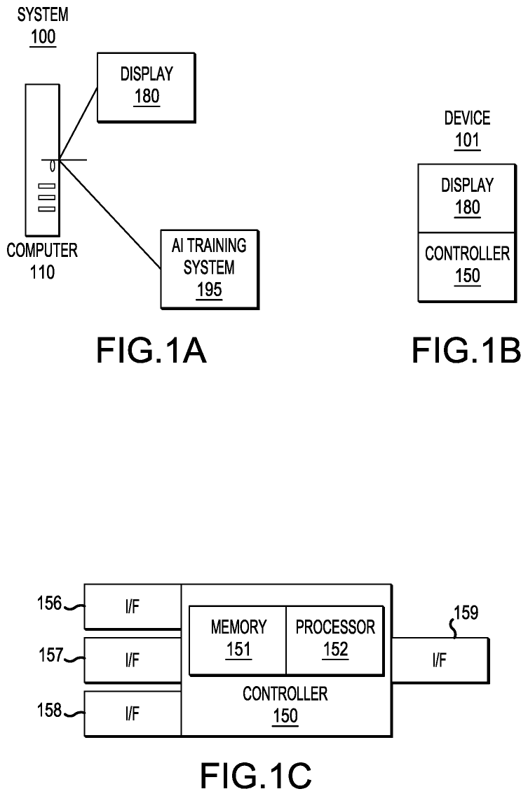

FIG. 1A illustrates a system 100 for interactive configuration of deployed detection models, in accordance with a representative embodiment.

The system 100 in FIG. 1A is a system for interactive configuration of deployed detection models and includes components that may be provided together or that may be distributed. The system 100 includes a computer 110, a display 180 and an AI training system 195. Throughout the description, a deployed detection model is trained based on data such that thresholds for output of the detection model may be tunable. A deployed detection model may be a trained artificial intelligence model, such as a trained machine learning model.

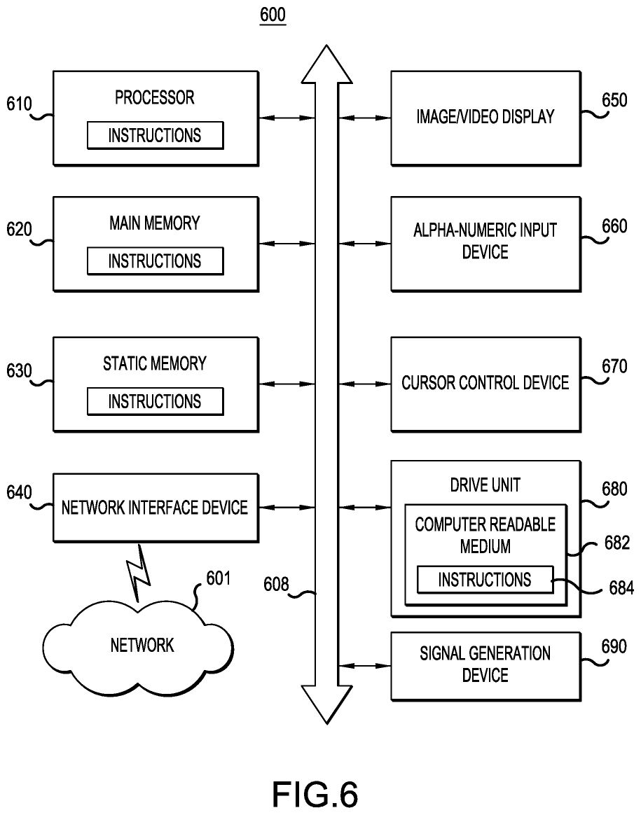

The computer 110 includes a controller 150. The controller 150 is further depicted in FIG. 1C, and includes at least a memory 151 that stores instructions and a processor 152 that executes the instructions. A computer that can be used to implement the computer 110 is depicted in FIG. 6, though a computer 110 may include fewer or more elements than depicted in FIG. 6. The computer 110 may be interfaced with user input devices by which users can input instructions, including mouses, keyboards, thumbwheels and so on.

The display 180 may be local to the computer 110 or may be remotely connected to the computer 110. The display 180 may be connected to the computer 110 via a local wired interface such as an Ethernet cable or via a local wireless interface such as a Wi-Fi connection. The display 180 may be interfaced with user input devices by which users can input instructions, including mouses, keyboards, thumbwheels and so on.

The display 180 may be a monitor such as a computer monitor, a display on a mobile device, an augmented reality display, a television, an electronic whiteboard, or another screen configured to display electronic imagery. The display 180 may also include an interactive touch screen configured to display prompts to users and collect touch input from users. User instructions may be input to the system 100 by the display 180, or via other user input devices by which users can input instructions.

The display 180 serves as an interface configured to display a classifier detection threshold and the effects of changing the classifier detection threshold. The changes may be input via the display 180 if the display 180 is a touch display. Otherwise, a change to the classifier detection threshold may be implemented via selecting a location on the display 180 corresponding to a cursor manipulated by a mouse. As a result of the interactive ability to select and change the classifier detection threshold and see the prospective result of changing the classifier detection threshold, a user may configure and customize a trained detection model as described herein. The display 180 may comprise an interface that accepts selections of classifier detection thresholds including a first classifier detection threshold and a second classifier detection threshold, so that a user can perceive corresponding false alarm gains, precision values and recall values corresponding to each of the classifier detection thresholds.

The AI training system 195 is representative of a system wherein a classification model is trained. The AI training system 195 may be provided by a software developer that develops detection models for end users, such as for sale over the internet or for intra-organizational use by a different department of a company that includes the software developer. The AI training system may include one or more computers with memories that stores instructions and processors that execute the instructions to develop trained detection models. As described herein, trained detection models are also provided with data of coordinate sets corresponding to precision values and false alarm gain values which are determined from testing and/or developing the trained detection models. As described elsewhere herein, the result of training detection models may include setting a preset classifier detection threshold for the detection models. The preset classifier detection threshold may be adjusted upon deployment of detection models using the teachings herein which enable adjustment of the preset classifier detection thresholds by showing relevant effects of the adjustment to users and allowing the users to persistently reset the classifier detection thresholds for use. Each instance of data of coordinate sets of a precision value and a false alarm gain value corresponds to a selectable classifier detection threshold which may be selected to change the preset classifier detection threshold.

The interactive configuration enabled by the teachings herein may be built with the use of a graphical user interface development tool. For example, a web browser may be used to develop the graphical user interface. The generation of the interactive graphical user interface requires that the detection model be deployed with its test performance information. For example, for each classifier detection threshold that may be selected for the detection model, a corresponding false alarm gain, precision value and recall value may be provided.

FIG. 1B illustrates a device for interactive configuration of deployed detection models, in accordance with a representative embodiment.

In FIG. 1B, the device 101 includes the controller 150 and the display 180. FIG. 1B shown an example wherein a configuration of a deployed detection model may be input to the controller 150 or to the display 180 on a single device, based on an interactive display to a user via the display 180.

FIG. 1C illustrates the controller 150 for interactive configuration of deployed detection models, in accordance with a representative embodiment.

The controller 150 includes a memory 151, a processor 152, a first interface 156, a second interface 157, a third interface 158, and a fourth interface 159. The memory 151 stores instructions which are executed by the processor 152. The processor 152 executes the instructions. The first interface 156, the second interface 157 and the third interface 158 may include ports, disk drives, wireless antennas, or other types of receiver circuitry used to output and input data from other electronic components. The fourth interface 159 may be a user interface that accepts user input via another electronic device, such as a mouse, a keyboard or microphone/speaker combination.

The controller 150 may perform some of the operations described herein directly and may implement other operations described herein indirectly. For example, the controller 150 may directly perform logical operations by executing instructions. The controller 150 may indirectly control other operations such as by generating and transmitting content to be displayed on the display 180. Accordingly, the processes implemented by the controller 150 when the processor 152 executes instructions from the memory 151 may include steps not directly performed by the controller 150.

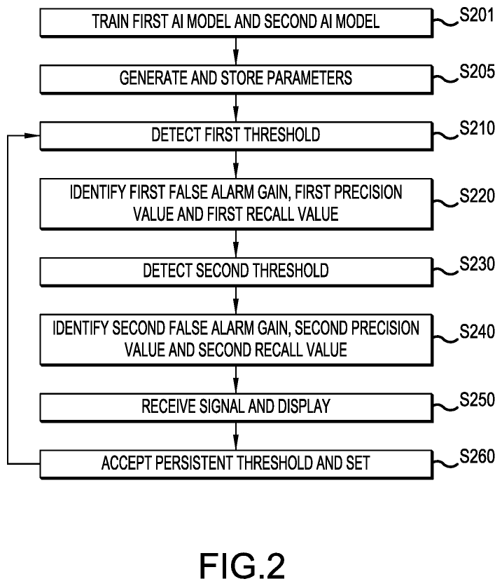

FIG. 2 illustrates a method for interactive configuration of deployed detection models, in accordance with a representative embodiment.

The method in FIG. 2 starts by training a classification model at S201. The training at S201 may be performed by the AI training system 195. The training at S201 may include training a first artificial intelligence model, a second artificial intelligence model, a third artificial intelligence model, and so on. That is, the AI training system 195 may be configured to train many different instances of trained artificial intelligence models.

At S205, threshold parameters corresponding to classifier detection thresholds for a trained detection model are stored along with performance information associated with the threshold parameter. The threshold parameters may be set, and then performance information may be generated and stored for different settings of the threshold parameters. S205 may be performed at the AI training system 195, or at another device or system after the trained detection model is developed. The threshold parameters and associated performance information may be stored at the AI training system 195 before the trained detection model and the data of coordinate sets for the threshold parameters and associated performance information are provided to end users. As set forth above, the data of coordinate sets correspond to precision values and false alarm gain values for each value of the threshold parameter, and are determined from testing and/or developing the trained detection models

At S210, a first classifier detection threshold is detected. The first classifier detection threshold may be the preset classifier detection threshold, or may be an adjustment to the preset classifier detection threshold interactively input by a user as an instruction. The user is enabled to provide an interactive input of changes to selected classifier detection thresholds. The first classifier detection threshold may be detected when the trained detection model is initiated at the computer 110, and may be the preset detection threshold or a previously adjusted value of the classifier detection threshold.

At S220, the method of FIG. 2 include identifying a first false alarm gain, a first precision value, and a first recall value. The identification at S220 may be performed by the computer 110, is based on detecting the first classifier detection threshold at S210, and includes obtaining the data of a coordinate set corresponding to the first classifier detection threshold.

At S230, a second classifier detection threshold is detected. The second classifier detection threshold may be detected based on a user moving a cursor on a screen of the display 180 to adjust the classifier detection threshold for the trained detection model. The second classifier detection threshold may be a possible adjustment to the preset classifier detection threshold or may be an adjustment to an adjustment to the preset classifier detection threshold. That is, the second classifier detection threshold may be detected when the trained detection model is run at the computer 110, and the interactive graphical user interface provided for the trained detection model enables a user to adjust the classifier detection threshold to a second level/value.

At S240, the method of FIG. 2 includes identifying a second false alarm gain, a second precision value, and a second recall value. The identification at S240 may be performed by the computer 110, is based on detecting the second classifier detection threshold at S230, and includes obtaining the data of a coordinate set corresponding to the second classifier detection threshold.

At S250, a signal that includes the first false alarm gain, the first precision value, the first recall value, the second false alarm gain, the second precision value and the second recall value is output, such as by the controller 150, and received, such as by the display 180. The display 180 is configured to simultaneously display the first false alarm gain, the first precision value, the first recall value, the second false alarm gain, the second precision value and the second recall value. Additionally, the display 180 is configured to display changes from the first false alarm gain, the first precision value, and the first recall value based on changes in the threshold parameter. The changes will show to the user the effects of changing from the threshold parameter to another threshold parameter. Of course, the signal at S250 does not have to be output simultaneously, even if the noted information is displayed on the display 180 together. Rather, a selected classifier detection threshold and associated data of a coordinate set may be output each time a user selects a new classifier detection threshold, such as by moving a cursor on the display 180.

At S260, a persistent classifier detection threshold is set. The persistent classifier detection threshold is set at the computer 110, and may be the default setting for the trained detection model going forward. The persistent classifier detection threshold may be set as a default to use going forward for the trained detection model. The persistent classifier detection threshold may be different from the original classifier detection threshold, and may be configured and customized by a user using the interactive graphical user interface described herein. The persistent classifier detection threshold may be accepted and set by the user, such as to replace the preset classifier detection threshold set at the AI training system 195.

The process in FIG. 2 may return to S210 after the signal is received and the display is generated at S250, such as when another classifier detection threshold is being input by a user.

In the method of FIGS. 2, S210, S220, S230, S240, S250 and S260 may be performed by the controller 150, by the system 100 including the computer 110 which includes the controller 150, or by the device 101 which includes the controller 150.

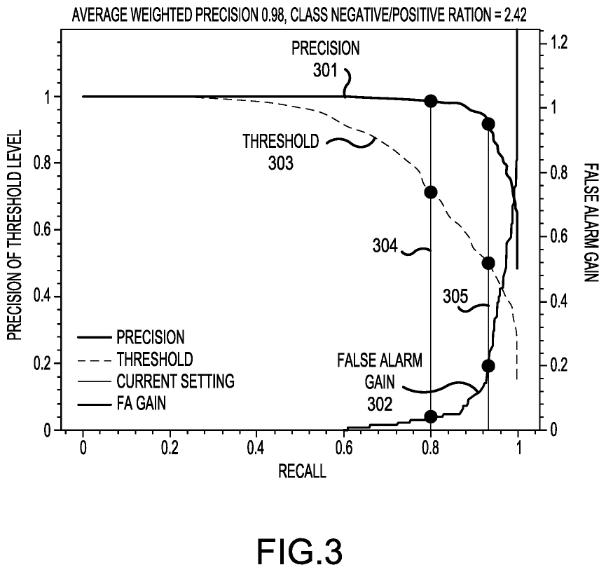

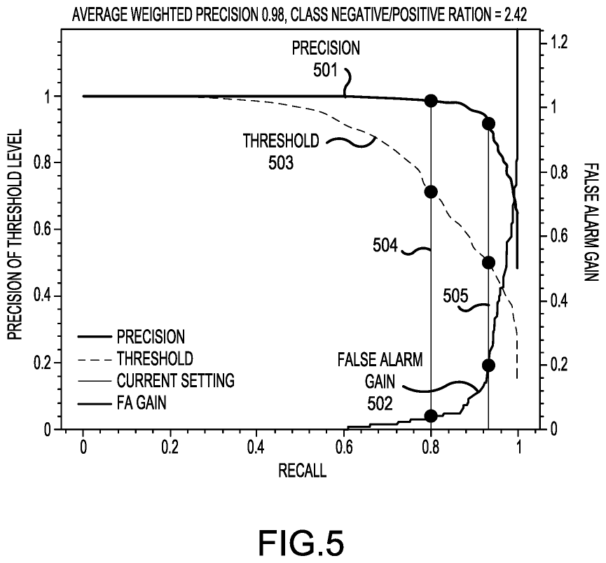

Several example interactive graphical user interfaces are shown in and described with respect to FIG. 3 and FIG. 5 herein, and these graphical user interfaces may be implemented via the computer 110 and the display 180 in FIG. 1A or in FIG. 1B.

The detection model may be deployed with its test performance information. For example, for each classifier detection threshold that may be selected for the detection model, a corresponding false alarm gain, precision value and recall value may be provided. Using the interactive graphical user interfaces in FIG. 3 and in FIG. 5, a user may be enabled to select classifier detection thresholds. For each classifier detection threshold that may be selected to measure the test performance of the detection model, the graphical user interface may map to a classifier output value between, for example, 0 and 1. The graphical user interface may also require a classification result. Classification results may include, for example, True Positive (TP), False Positive (FP), and False Negative (FN). The graphical user interface may also require a negative to positive class ratio. The negative to positive class ratio may be labeled NPratio, and may equal a ratio of the number of negatives relative to the number of positives.

FIG. 3 illustrates an interactive graphical user interface for interactive configuration of deployed detection models, in accordance with a representative embodiment.

In FIG. 3, the interactive graphical user interface is an aid that assists users in configuring classifier detection threshold settings for deployed machine learning models. The interactive graphical user interface in FIG. 3 may be generated by the computer 110 when a user initiates a trained detection model, such as for the first time. The processor 152 of the controller 150 may retrieve and execute instructions for the trained detection model from the memory 151 to generate the interactive graphical user interface. The original settings are shown by the three dots on the vertical line segment 305 on the right, and alternative settings selected by the user are shown by the three dots on the vertical line segment 304 on the left. Three curves shown in FIG. 3 include precision 301, false alarm gain 302, and threshold 303. Performance may be analyzed in terms of how accurate the machine learning model is in detecting positives, or the quality of the detection (i.e., precision 301). Performance may also be analyzed in terms of how many positives will be detected, or the quantity of the detection (i.e., recall). Performance may also be analyzed in terms of how many false alarms are generated per positive (i.e., false alarm gain 302).

As an example, the data of 1000 coordinate sets may be provided with the trained detection model. For each of 1000 threshold values, corresponding coordinates for precision and false alarm gain may be provided separately. In some embodiments, the data of coordinate sets may be provided mostly or entirely at uniform spacing along the recall axis, such as for every 1/1000 increment from 0 through 1. When the data of coordinate sets is not entirely uniform along the recall axis, some of the coordinate sets may be concentrated, such as in an area along the recall axis where the developers of the detection model understand end users are most likely to adjust the classifier detection threshold levels. The description of the data of coordinate sets may be provided for 100 classifier detection threshold values, or for 1000, 2000, 5000 or 10000 classifier detection threshold values, depending on the granularity which end users are most likely to demand.

Users can use the interactive graphical user interface in FIG. 3 in selecting the appropriate operating classifier detection threshold levels for machine learning classifiers. The example in FIG. 3 is built for a machine learning model for detection of ineffective triggering during exhalation on VX850 ventilator waveforms. The graphical user interface enables the user to make informed choices on classifier detection threshold levels by contextualizing the expected false alarm rates. Thus, an important aspect of the graphical user interface is the false alarm gain y-axis labelled on the right side and marking the curve that increases to the top of the graphical user interface. The false alarm gain marked by the curve that increases to the top of the graphical user interface is superimposed on the precision recall curve which drops from a horizontal alignment. Classifier detection threshold values are marked by the broken line with the vertically-middle dots on the graphical user interface. The default threshold is set at 0.5 at vertical line segment 305 in FIG. 3. Using the curves and values, the user is able to manipulate a cursor to sweep across different classifier detection threshold values and quickly analyze performance by seeing how much a change in classifier detection threshold results in a change in the false alarm gain and a change in the precision value.

The AI training system 195 may provide sets of data for each potential classifier detection threshold level. The sets of data may be analogous to coordinate data, and may include a precision value and a recall value for each classifier detection threshold level. The precision values and recall values may be determined from testing the trained detection application. As an example, an individual instance of data of a coordinate set may be formatted as 1 or more 64-bit processing words, wherein two bytes are allocated for more than 65000 potential precision values, two bytes are allocated for more than 65000 potential recall values, and as little as one byte is allocated for more than 200 potential classifier detection threshold levels. As should be evident, the complete package of data of coordinate sets that accompany the trained detection application may be on the order of 1 kilobyte in size, though the amounts of data may be smaller or larger depending on the range and level of detail at which classifier detection threshold levels, precision values and recall values are stated.

As further explanation, the graphical user interface in FIG. 3 shows the precision recall curve. The precision values are defined on the Y axis on the right side as precision=TP/(TP+FP). The recall values are defined on the X axis as recall=TP/(TP+FN). TP is defined as the plotting of the machine learning model classifier detection threshold values for each point on the precision recall curve. The classifier detection threshold value for each point in the precision recall curve is also plotted in FIG. 3. A second y-axis on the right corresponds to the false alarm gain. False alarm gain is given by (1−Precision)*NPratio. The default classifier detection threshold value shipped by the classifier and the corresponding points on the recall and false alarm gain curves are also plotted.

The two vertical lines connect all the points on the three curves, and help the user understand how all points are related and how changing the classifier detection threshold (by sweeping through the classifier detection threshold curve) affects the precision value and the false alarm gain value. The precision and false alarm gain values are tracked by finding the recall point at the selected classifier detection threshold value since the recall and the classifier detection threshold share the X-axis.

In FIG. 3, the user can select a new classifier detection threshold value by dragging the black vertical line along the x-axis. For example, in FIG. 3 the default threshold of 0.5 (vertical line segment 305) is dragged by the user to a select a new threshold value, and vertical line segment 305 becomes vertical line segment 304. Once a value is chosen, the user clicks on the graph and the new classifier detection threshold value overwrites the default setting on the deployed machine learning model.

In some embodiments based on FIG. 3, the user may configure the plot by providing their own estimate of the NPratio based on their experience or their data. Once these plot are available the users can then interactive and understand how to change the classifier detection threshold in a way that is relevant to their own needs.

As an example, a default setting in FIG. 3 may be a threshold of 0.5, a recall of 93.8, a precision of 91.7 and a false alarm gain of 0.2. An alternative selective setting in FIG. 3 may be a threshold of 70.7 with a recall of 80.0, a precision of 98.0 and a false alarm gain of 0.04.

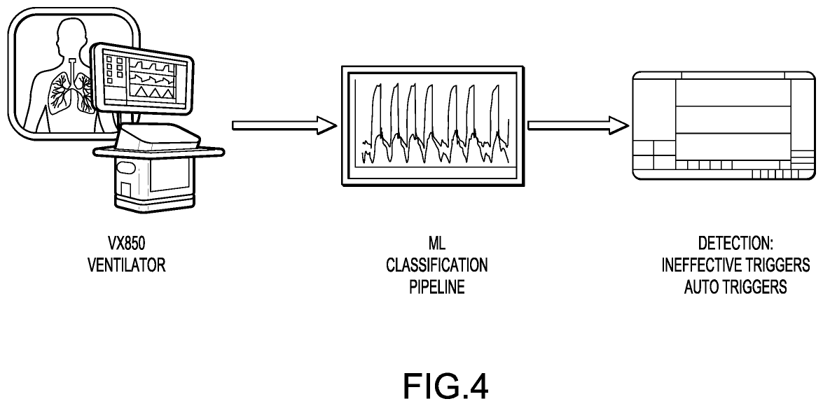

FIG. 4 illustrates an example application of interactive graphical user interface for interactive configuration of deployed detection models, in accordance with a representative embodiment.

FIG. 4 shows an example of an application of the teachings herein. In the example shown in FIG. 4, a machine learning model is deployed on the VX850 ventilator for automated detection of asynchrony breaths. A user of the machine learning model may select classifier detection thresholds by viewing the tradeoff in precision and false alarm gain as different classifier detection thresholds are selected. A display shown on the VX850 ventilator in FIG. 4 may correspond to the display 180, and a computer shown at the workstation for the VX850 ventilator in FIG. 4 may correspond to the computer 110. A trained detection model is applied to output of the VX850 ventilator to detect asynchrony breaths, and the operator of the VX850 ventilator may adjust the classifier detection thresholds for the trained detection model according to the operator's preferences.

FIG. 5 illustrates another interactive graphical user interface for interactive configuration of deployed detection models, in accordance with a representative embodiment.

The interactive graphical user interface in FIG. 5 may be generated by the computer 110 when a user initiates a trained detection model, such as for the first time. The processor 152 of the controller 150 may retrieve and execute instructions for the trained detection model from the memory 151 to generate the interactive graphical user interface. As shown, the interactive graphical user interface in FIG. 5 again includes three curves, i.e., for precision 501, for false alarm gain 502, and for the threshold 503. Two vertical lines marking the selections of the threshold include the first vertical line 504 for the first setting and the second vertical line 505 for the second setting.

The interactive graphical user interface described herein may be applied to any classification or detection task that would allow the user to change or select threshold values in a way that is relevant to their own needs or circumstances. The interactive graphical user interface may be applied to the patient-ventilator asynchrony detection system in FIG. 4, such as by a machine learning model deployed on the VX850 ventilator to automatically detect asynchronous breaths from the ventilator waveform data. Nevertheless, the interactive graphical user interface described herein may be applied to other classification or detection tasks in which changes in classifier detection thresholds may be of interest.

In some embodiments, the user may also be provided an ability to configure the classifier detection threshold values via a configuration display provided as an application together with the trained detection model. The configuration display may generate an interactive graphical user interface similar to that in FIG. 5, which shows an interactive graphical user interface for patient-ventilator automatic asynchrony detection. The interaction allows the user to configure the classifier detection threshold settings relative to the users tolerance for false alarms. The classifier detection thresholds may be updated automatically by clicking and confirming a point on the classifier detection threshold curve on the display 180. The vertical lines help the user understand how the classifier detection threshold point impacts the precision value and the false alarm gain.

The user can select a new threshold value by dragging the black vertical line along the x-axis. Once a value for the threshold is chosen, the user clicks on the graph and the new threshold value is uploaded and the old default setting gets overwritten on the deployed ML model. This enables the user to easily configure a new threshold for automatic asynchrony detection based on the user's tolerance for false alarms and quality of prediction. For instance, in the example in FIG. 5, the user generates an alternative threshold setting with minor changes in recall and precision, but a very large improvement in the false alarm gain, i.e., a 5-fold decrease in the number of false alarms generated. This magnified effect illustrates the benefit to a user of being able to selectively configure a threshold.

FIG. 6 illustrates a computer system, on which a method for interactive configuration of deployed detection models is implemented, in accordance with another representative embodiment.

Referring to FIG. 6, the computer system 600 includes a set of software instructions that can be executed to cause the computer system 600 to perform any of the methods or computer-based functions disclosed herein. The computer system 600 may operate as a standalone device or may be connected, for example, using a network 601, to other computer systems or peripheral devices. In embodiments, a computer system 600 performs logical processing based on digital signals received via an analog-to-digital converter.

In a networked deployment, the computer system 600 operates in the capacity of a server or as a client user computer in a server-client user network environment, or as a peer computer system in a peer-to-peer (or distributed) network environment. The computer system 600 can also be implemented as or incorporated into various devices, such as a workstation that includes a controller, a stationary computer, a mobile computer, a personal computer (PC), a laptop computer, a tablet computer, or any other machine capable of executing a set of software instructions (sequential or otherwise) that specify actions to be taken by that machine. The computer system 600 can be incorporated as or in a device that in turn is in an integrated system that includes additional devices. In an embodiment, the computer system 600 can be implemented using electronic devices that provide voice, video or data communication. Further, while the computer system 600 is illustrated in the singular, the term “system” shall also be taken to include any collection of systems or sub-systems that individually or jointly execute a set, or multiple sets, of software instructions to perform one or more computer functions.

As illustrated in FIG. 6, the computer system 600 includes a processor 610. The processor 610 may be considered a representative example of a processor of a controller and executes instructions to implement some or all aspects of methods and processes described herein. The processor 610 is tangible and non-transitory. As used herein, the term “non-transitory” is to be interpreted not as an eternal characteristic of a state, but as a characteristic of a state that will last for a period. The term “non-transitory” specifically disavows fleeting characteristics such as characteristics of a carrier wave or signal or other forms that exist only transitorily in any place at any time. The processor 610 is an article of manufacture and/or a machine component. The processor 610 is configured to execute software instructions to perform functions as described in the various embodiments herein. The processor 610 may be a general-purpose processor or may be part of an application specific integrated circuit (ASIC). The processor 610 may also be a microprocessor, a microcomputer, a processor chip, a controller, a microcontroller, a digital signal processor (DSP), a state machine, or a programmable logic device. The processor 610 may also be a logical circuit, including a programmable gate array (PGA), such as a field programmable gate array (FPGA), or another type of circuit that includes discrete gate and/or transistor logic. The processor 610 may be a central processing unit (CPU), a graphics processing unit (GPU), or both. Additionally, any processor described herein may include multiple processors, parallel processors, or both. Multiple processors may be included in, or coupled to, a single device or multiple devices.

The term “processor” as used herein encompasses an electronic component able to execute a program or machine executable instruction. References to a computing device comprising “a processor” should be interpreted to include more than one processor or processing core, as in a multi-core processor. A processor may also refer to a collection of processors within a single computer system or distributed among multiple computer systems. The term computing device should also be interpreted to include a collection or network of computing devices each including a processor or processors. Programs have software instructions performed by one or multiple processors that may be within the same computing device or which may be distributed across multiple computing devices.

The computer system 600 further includes a main memory 620 and a static memory 630, where memories in the computer system 600 communicate with each other and the processor 610 via a bus 608. Either or both of the main memory 620 and the static memory 630 may be considered representative examples of a memory of a controller, and store instructions used to implement some or all aspects of methods and processes described herein. Memories described herein are tangible storage mediums for storing data and executable software instructions and are non-transitory during the time software instructions are stored therein. As used herein, the term “non-transitory” is to be interpreted not as an eternal characteristic of a state, but as a characteristic of a state that will last for a period. The term “non-transitory” specifically disavows fleeting characteristics such as characteristics of a carrier wave or signal or other forms that exist only transitorily in any place at any time. The main memory 620 and the static memory 630 are articles of manufacture and/or machine components. The main memory 620 and the static memory 630 are computer-readable mediums from which data and executable software instructions can be read by a computer (e.g., the processor 610). Each of the main memory 620 and the static memory 630 may be implemented as one or more of random access memory (RAM), read only memory (ROM), flash memory, electrically programmable read only memory (EPROM), electrically erasable programmable read-only memory (EEPROM), registers, a hard disk, a removable disk, tape, compact disk read only memory (CD-ROM), digital versatile disk (DVD), floppy disk, blu-ray disk, or any other form of storage medium known in the art. The memories may be volatile or non-volatile, secure and/or encrypted, unsecure and/or unencrypted.

“Memory” is an example of a computer-readable storage medium. Computer memory is any memory which is directly accessible to a processor. Examples of computer memory include, but are not limited to RAM memory, registers, and register files. References to “computer memory” or “memory” should be interpreted as possibly being multiple memories. The memory may for instance be multiple memories within the same computer system. The memory may also be multiple memories distributed amongst multiple computer systems or computing devices.

As shown, the computer system 600 further includes a video display unit 650, such as a liquid crystal display (LCD), an organic light emitting diode (OLED), a flat panel display, a solid-state display, or a cathode ray tube (CRT), for example. Additionally, the computer system 600 includes an input device 660, such as a keyboard/virtual keyboard or touch-sensitive input screen or speech input with speech recognition, and a cursor control device 670, such as a mouse or touch-sensitive input screen or pad. The computer system 600 also optionally includes a disk drive unit 680, a signal generation device 690, such as a speaker or remote control, and/or a network interface device 640.

In an embodiment, as depicted in FIG. 6, the disk drive unit 680 includes a computer-readable medium 682 in which one or more sets of software instructions 684 (software) are embedded. The sets of software instructions 684 are read from the computer-readable medium 682 to be executed by the processor 610. Further, the software instructions 684, when executed by the processor 610, perform one or more steps of the methods and processes as described herein. In an embodiment, the software instructions 684 reside all or in part within the main memory 620, the static memory 630 and/or the processor 610 during execution by the computer system 600. Further, the computer-readable medium 682 may include software instructions 684 or receive and execute software instructions 684 responsive to a propagated signal, so that a device connected to a network 601 communicates voice, video or data over the network 601. The software instructions 684 may be transmitted or received over the network 601 via the network interface device 640.

In an embodiment, dedicated hardware implementations, such as application-specific integrated circuits (ASICs), field programmable gate arrays (FPGAs), programmable logic arrays and other hardware components, are constructed to implement one or more of the methods described herein. One or more embodiments described herein may implement functions using two or more specific interconnected hardware modules or devices with related control and data signals that can be communicated between and through the modules. Accordingly, the present disclosure encompasses software, firmware, and hardware implementations. Nothing in the present application should be interpreted as being implemented or implementable solely with software and not hardware such as a tangible non-transitory processor and/or memory.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing may implement one or more of the methods or functionalities as described herein, and a processor described herein may be used to support a virtual processing environment.

Accordingly, interactive configuration of deployed detection models provides a graphical user interface (GUI) that helps a user select and set operating classifier detection thresholds for deployed machine learning models. The graphical user interface is interactive and provides information that is intuitive and useful for the user in order to understand the impact on false alarm. The adjustable classifier detection thresholds may be provided for detection systems trained based on data, including in diverse fields such as the medical field, the communications field, threat detection systems in military applications, and other similar fields where end users may benefit from an ability to adjust classifier detection thresholds according to their own preferences and concerns.

Although interactive configuration of deployed detection models has been described with reference to several exemplary embodiments, it is understood that the words that have been used are words of description and illustration, rather than words of limitation. Changes may be made within the purview of the appended claims, as presently stated and as amended, without departing from the scope and spirit of interactive configuration of deployed detection models in its aspects. Although interactive configuration of deployed detection models has been described with reference to particular means, materials and embodiments, interactive configuration of deployed detection models is not intended to be limited to the particulars disclosed; rather interactive configuration of deployed detection models extends to all functionally equivalent structures, methods, and uses such as are within the scope of the appended claims.

The illustrations of the embodiments described herein are intended to provide a general understanding of the structure of the various embodiments. The illustrations are not intended to serve as a complete description of all of the elements and features of the disclosure described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The preceding description of the disclosed embodiments is provided to enable any person skilled in the art to practice the concepts described in the present disclosure. As such, the above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

1. A system, comprising:
a memory that stores instructions, a threshold parameter corresponding to classifier detection thresholds for a trained detection model, and performance information associated with the threshold parameter; and
a processor that executes the instructions, which when executed by the processor, cause the processor to:
detect a first classifier detection threshold set for the trained detection model;
identify, for the first classifier detection threshold, a first false alarm gain, a first precision value and a first recall value;
detect a second classifier detection threshold set for the trained detection model;
identify, for the second classifier detection threshold, a second false alarm gain, a second precision value and a second recall value; and
output a signal that includes the first false alarm gain, the first precision value, the first recall value, the second false alarm gain, the second precision value and the second recall value.

2. The system of claim 1, further comprising:
a display adapted to receive the signal and display the first false alarm gain, the first precision value, the first recall value, the second false alarm gain, the second precision value and the second recall value.

3. The system of claim 1, wherein the instructions, when executed by the processor, cause the system to accept a persistent classifier detection threshold for the trained detection model based on an interactive setting accepted based on outputting the signal.

4. The system of claim 2,
wherein the display is configured to simultaneously display the first false alarm gain, the first precision value, the first recall value, the second false alarm gain, the second precision value and the second recall value.

5. The system of claim 2, wherein the display is configured to display changes from the first false alarm gain, the first precision value, and the first recall value based on changes in the threshold parameter.

6. The system of claim 2, further comprising:
an interface configured to accept interactive input of changes in the threshold parameter.

7. The system of claim 2, further comprising:
an interface that accepts selections of classifier detection thresholds including the first classifier detection threshold and the second classifier detection threshold,
wherein, when executed by the processor, the instructions cause the system to identify false alarm gains, precision values and recall values corresponding to selected classifier detection thresholds.

8. The system of claim 7,
wherein the performance information stored in the memory includes the false alarm gains, the precision values and the recall values corresponding to selected classifier detection thresholds.

9. The system of claim 8,
wherein the performance information stored in the memory, including the false alarm gains, the precision values and the recall values corresponding to selected classifier detection thresholds, are provided with the trained detection model.

10. A method, comprising:
storing, in a memory, instructions, a threshold parameter corresponding to classifier detection thresholds for a trained detection model, and performance information associated with the threshold parameter;
detecting, by a processor, a first classifier detection threshold set for the trained detection model;
identifying, by the processor for the first classifier detection threshold, a first false alarm gain, a first precision value and a first recall value;
detecting, by the processor, a second classifier detection threshold set for the trained detection model;
identifying, by the processor for the second classifier detection threshold, a second false alarm gain, a second precision value and a second recall value; and
outputting a signal that includes the first false alarm gain, the first precision value, the first recall value, the second false alarm gain, the second precision value and the second recall value.

11. The method of claim 10, further comprising:
receiving, by a display, the signal;
displaying first false alarm gain, the first precision value, the first recall value, the second false alarm gain, the second precision value and the second recall value, and
accepting, by the processor, a persistent classifier detection threshold for the trained detection model based on an interactive setting accepted based on outputting the signal.

12. The method of claim 10, further comprising:
accepting selections of classifier detection thresholds including the first classifier detection threshold and the second classifier detection threshold; and
identifying false alarm gains, precision values and recall values corresponding to selected classifier detection thresholds.

13. The method of claim 12,
wherein the performance information stored in the memory includes the false alarm gains, the precision values and the recall values corresponding to selected classifier detection thresholds.

14. The method of claim 13,
wherein the performance information stored in the memory, including the false alarm gains, the precision values and the recall values corresponding to selected classifier detection thresholds, are provided with the trained detection model.

15. A controller, comprising:
a memory that stores instructions, a threshold parameter corresponding to classifier detection thresholds for a trained detection model, and performance information associated with the threshold parameter; and
a processor that executes the instructions, wherein, when executed by the processor, the instructions cause the processor to:
detect a first classifier detection threshold set for the trained detection model;
identify, for the first classifier detection threshold, a first false alarm gain, a first precision value and a first recall value;
detect a second classifier detection threshold set for the trained detection model;
identify, for the second classifier detection threshold, a second false alarm gain, a second precision value and a second recall value; and
output a signal that includes the first false alarm gain, the first precision value, the first recall value, the second false alarm gain, the second precision value and the second recall value.

16. The controller of claim 15,
wherein, when executed by the processor, the instructions cause the controller to accept a persistent classifier detection threshold for the trained detection model based on an interactive setting accepted based on outputting the signal.

17. The controller of claim 15,
wherein, when executed by the processor, the instructions cause the controller to identify false alarm gains, precision values and recall values corresponding to selected classifier detection thresholds.

18. The controller of claim 17,
wherein the performance information stored in the memory includes the false alarm gains, the precision values and the recall values corresponding to selected classifier detection thresholds.

19. The controller of claim 18,
wherein the performance information stored in the memory, including the false alarm gains, the precision values and the recall values corresponding to selected classifier detection thresholds, are provided with the trained detection model.

20. A tangible non-transitory computer readable storage medium that stores a computer program, a threshold parameter corresponding to classifier detection thresholds for a trained detection model, and performance information associated with the threshold parameter, wherein the computer program, when executed by a processor, causes a computer apparatus to:
detect a first classifier detection threshold set for the trained detection model;
identify, for the first classifier detection threshold, a first false alarm gain, a first precision value and a first recall value;
detect a second classifier detection threshold set for the trained detection model;
identify, for the second classifier detection threshold, a second false alarm gain, a second precision value and a second recall value; and
output a signal that includes the first false alarm gain, the first precision value, the first recall value, the second false alarm gain, the second precision value and the second recall value.
